(19) United States
(12) Patent Application Publication
(10) Pub. No.: US 2018/0297612 A1
(43) Pub. Date: Oct. 18, 2018

(54) AUTONOMOUS DRIVING DEVICE AND NOTIFICATION METHOD

(71) Applicant: TOYOTA JIDOSHA KABUSHIKI KAISHA, Toyota-shi (JP)

(72) Inventor: Hideo FUKAMACHI, Hadano-shi (JP)

(73) Assignee: TOYOTA JIDOSHA KABUSHIKI KAISHA, Toyota-shi (JP)

(21) Appl. No.: 15/948,443

(22) Filed: Apr. 9, 2018

(30) Foreign Application Priority Data
Apr. 13, 2017 (JP) 2017-079816

(51) Int. Cl. B60W 50/14; G05D 1/00; B60W 50/08

(52) U.S. Cl. CPC B60W 50/14; G05D 1/0088; B60W 50/08; B60W 2540/00; B60W 2050/143; B60W 2550/402; B60W 2550/406; G05D 2201/0212

(57) ABSTRACT

An autonomous driving device includes: a traveling control unit configured to cause a vehicle to autonomously travel to a destination; an arrival determination unit configured to determine whether the vehicle has arrived at the destination; a getting in-out detection unit configured to detect whether an occupant has gotten in or gotten out of the vehicle; and a notification unit configured to send a notification to an outside of the vehicle when the getting in-out detection unit does not detect that the occupant has gotten in or gotten out of the vehicle within a predetermined getting in-out determination time after the arrival determination unit determines that the vehicle has arrived at the destination.

### INCORPORATION BY REFERENCE

The disclosure of Japanese Patent Application No. 2017-079816 filed on Apr. 13, 2017 including the specification, drawings and abstract is incorporated herein by reference in its entirety.

### BACKGROUND

### 1. Technical Field

The present disclosure relates to an autonomous driving device and a notification method.

### 2. Description of Related Art

For example, Japanese Patent Application Publication No. 2016-115364 (JP 2016-115364 A) describes a technology that causes an autonomous vehicle, which can travel autonomously, to travel in unmanned mode for dispatch to a user.

### SUMMARY

There is sometimes a case in which, when an autonomous vehicle that travels in unmanned mode is dispatched to a user-specified destination, the user is not present at the destination even after the autonomous vehicle has arrived at the destination. In this case, the autonomous vehicle remains to stay there without the manager knowing the situation, sometimes leading to the possibility that the vehicle will obstruct the traveling of other vehicles and to the possibility that other users will not be able to use the autonomous vehicle. There is also a case in which, when an autonomous vehicle travels autonomously with an occupant in the vehicle and arrives at the destination, the occupant cannot get out of the vehicle due to an abnormality in the occupant's state. The present disclosure provides an autonomous driving device that sends a notification according to whether an occupant has gotten in or out of the vehicle after an autonomous vehicle capable of autonomous driving arrives at a preset destination.

An autonomous driving device according to a first aspect of the present disclosure includes: a traveling control unit configured to cause a vehicle to autonomously travel to a destination; an arrival determination unit configured to determine whether the vehicle has arrived at the destination; a getting in-out detection unit configured to detect whether an occupant has gotten in or gotten out of the vehicle; and a notification unit configured to send a notification to an outside of the vehicle when the getting in-out detection unit does not detect that the occupant has gotten in or gotten out of the vehicle within a predetermined getting in-out determination time after the arrival determination unit determines that the vehicle has arrived at the destination.

An autonomous driving device according to a second aspect of the present disclosure includes: an Electronic Control Unit configured to: cause a vehicle to autonomously travel to a destination; determine whether the vehicle has arrived at the destination; detect whether an occupant has gotten in or gotten out of the vehicle; and send a notification to an outside of the vehicle when getting in or getting out of the vehicle of the occupant is not detected within a predetermined getting in-out determination time after arrival of the vehicle at the destination is determined.

In the aspect described above, the traveling control unit is configured to cause the vehicle to travel in unmanned mode and the notification unit is configured to send the notification to the outside to indicate that the occupant has not gotten in the vehicle when the getting in-out detection unit does not detect that the occupant has gotten in the vehicle within the predetermined getting in-out determination time after the vehicle has arrived at the destination.

In the aspect described above, the traveling control unit may be configured to cause the vehicle to travel in manned mode and the notification unit may be configured to send the notification to the outside to indicate that the occupant has not gotten out of the vehicle when the getting in-out detection unit does not detect that the occupant has gotten out of the vehicle within the predetermined getting in-out determination time after the vehicle has arrived at the destination.

This autonomous driving device sends a notification to the outside of the vehicle if it is not detected that the occupant has gotten in or out of the vehicle within the getting-in/out determination time after it is determined that the vehicle has arrived at the destination. In this configuration, the autonomous driving device sends a notification as follows. For example, if the occupant cannot get out of the vehicle due to an abnormality in the occupant's state after the vehicle has travelled to the preset destination with the occupant in the vehicle, the autonomous driving device sends a notification to the outside the vehicle to notify about the condition. In addition, if a user is not present at the destination and, therefore, does not get in the vehicle after the vehicle has travelled to the preset destination with no occupant in the vehicle, the autonomous driving device sends a notification to the outside of the vehicle to notify about the condition. Based on these notifications, the notified manager can know that an abnormality has occurred in the vehicle or in the occupant's state. In this way, after the vehicle capable of autonomous driving arrives at the preset destination, the autonomous driving device can send a notification according to whether the occupant has gotten in/out of the vehicle.

In the aspect described above, the notification may be sent to a reception device external to the vehicle.

In the aspect described above, the notification may be output using a sound, a light, or a display.

In the aspect described above, the autonomous driving device may further include a travel plan generation unit configured to determine a route to the destination wherein the traveling control unit is configured to cause the vehicle to autonomously travel along the route.

In the aspect described above, the autonomous driving device may further include a destination acceptance unit configured to accept a setting of the destination.

In the aspect described above, the getting in-out detection unit may be configured to detect whether the occupant has gotten in or gotten out of the vehicle based on a detection result of a sensor or an image of an interior of the vehicle captured by a camera.

In the aspect described above, the sensor may include at least one of a door open-close sensor, a load sensor, a seating sensor, or an infrared ray sensor, the door open-close sensor may be configured to detect whether a door is open or closed, the load sensor may be configured to detect a weight of the vehicle, the seating sensor may be configured to detect a pressure applied to a seat.

In the aspect described above, the arrival determination unit may be configured to determine whether the vehicle has arrived at the destination based on vehicle position information including a position of the vehicle on a map at a time when the arrival determination unit determines whether the vehicle has arrived at the destination.

In the aspect described above, the position of the vehicle on the map may be recognized based on map information stored in a map database and Global Positioning System information entered externally.

In the aspect described above, the position of the vehicle on the map may be recognized based on map information stored in a map database and a detection result of an external sensor mounted on the vehicle, the external sensor being configured to detect a surrounding situation of the vehicle

In the aspect described above, the arrival determination unit may be configured to determine that the vehicle has arrived at the destination when the vehicle remains stationary at the destination continuously for a predetermined arrival determination time or longer after the vehicle arrives at the destination. This means that the autonomous driving device can detect that the vehicle has arrived at the destination, not when the vehicle simply passes the destination, but when the vehicle arrives at the destination and remains stationary there in the state in which the occupant can get in or out of the vehicle.

In the aspect described above, the autonomous driving device may further include a thing-left-behind detection unit configured to detect whether there is a thing left behind in the vehicle by comparing a state of the vehicle before the occupant gets in the vehicle and a state of the vehicle after the occupant gets out of the vehicle. The notification unit may be configured to send a notification to the outside of the vehicle when the getting in-out detection unit detects that the occupant has gotten out of the vehicle and when the thing-left-behind detection unit detects that there is a thing left behind. In this way, the autonomous driving device sends a notification to the outside if there is a thing left behind when the occupant gets out of the vehicle. This allows the notified administrator or the occupant, who gets out of the vehicle V, to know that there is a thing left behind in the vehicle V.

In the aspect described above, the notification may be sent to a reception device external to the vehicle.

In the aspect described above, the reception device may be a mobile terminal of the occupant.

A notification method is performed in an autonomous driving device causing a vehicle to autonomously travel along a route to a destination in manned mode or unmanned mode. The notification method comprising: determining whether the vehicle has arrived at the destination; and sending, after determining that the vehicle has arrived at the destination in the determining whether the vehicle has arrived at the destination, a notification to an outside of the vehicle when getting in or getting out of the vehicle of an occupant is not detected within a predetermined getting in-out determination time.

This notification method sends a notification to the outside of the vehicle if it is not detected that the occupant has gotten in/out of the vehicle within the predetermined getting-in/out determination time after it is determined that the vehicle has arrived at the destination. In this method, a notification is sent to the outside of the vehicle, for example, if the occupant cannot get out of the vehicle due to an abnormality in the occupant's state after the vehicle has travelled to the preset destination with the occupant in the vehicle. In this method, a notification is sent to the outside of the vehicle, for example, if a user is not present at the destination and, therefore, does not get in the vehicle after the vehicle has travelled to the preset destination with no occupant in the vehicle. Based on these notifications, the notified manager can know that an abnormality has occurred in the vehicle or in the occupant's state. In this way, after the vehicle capable of autonomous driving arrives at the preset destination, this notification method can send a notification according to whether the occupant has gotten in/out of the vehicle.

According to the aspects described above, a notification can be sent according to whether the occupant has gotten in or out of the vehicle after the vehicle capable of autonomous driving arrives at the preset destination.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing a general configuration of an autonomous driving device in an embodiment;

FIG. 2 is a flowchart showing a flow of notification processing executed when an autonomous driving device causes a vehicle to travel in manned mode; and

FIG. 3 is a flowchart showing a flow of notification processing executed when an autonomous driving device causes a vehicle to travel in unmanned mode.

### DETAILED DESCRIPTION OF EMBODIMENTS

An embodiment of the present disclosure will be described in detail below with reference to the attached drawings. In the description of the figures below, the same components have the same reference numeral and the duplicated description is omitted.

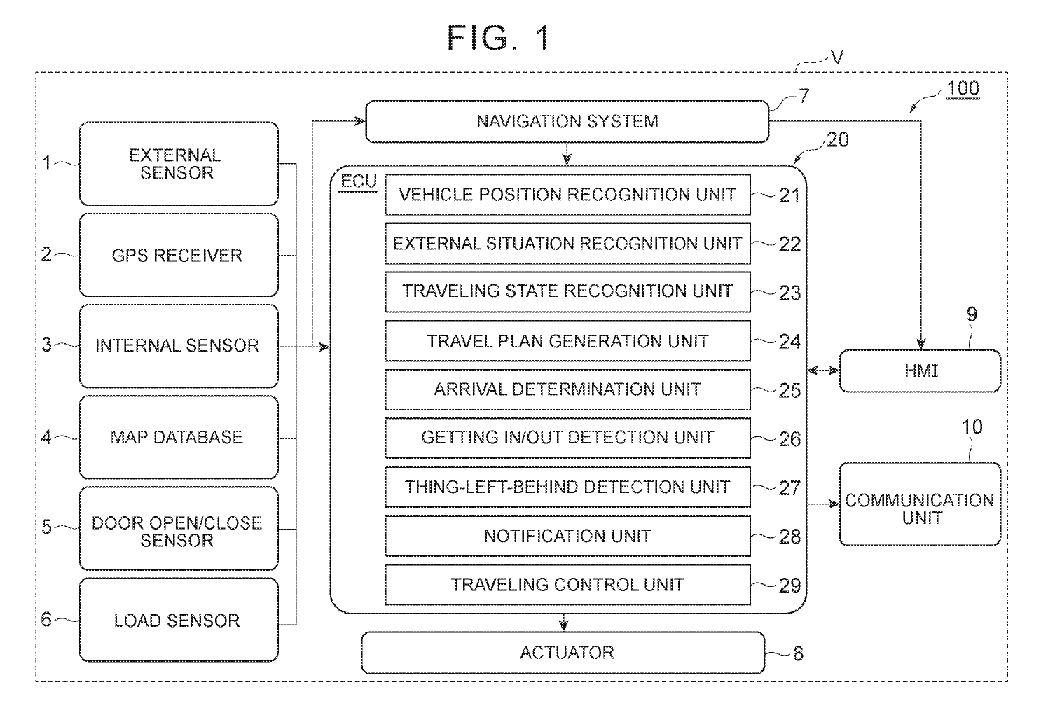

As shown in FIG. 1, an autonomous driving device 100 in this embodiment, mounted on a vehicle V such as a passenger car, performs autonomous driving control that causes the vehicle V to travel autonomously according to a travel plan that is generated in advance. The state in which autonomous driving control is performed refers to the driving state in which the control, including the speed control and the steering control of the vehicle V, is performed by the autonomous driving device 100.

The autonomous driving device 100 in this embodiment causes the vehicle V to travel autonomously to the destination, which is set by the occupant traveling in the vehicle V, in manned mode in which the occupant is in the vehicle V. The autonomous driving device 100 also causes the vehicle V to travel autonomously to the destination, which is set via wireless communication by the user of the vehicle V (a person who will use the vehicle V) or by the management center, in unmanned mode in which an occupant is not in the vehicle V. In the description below, the user of the vehicle V (a person who will use the vehicle V) refers to a person who will get in and travel in the vehicle V that has arrived at the destination. The management center refers to a center for managing the driving state of the vehicle V. For example, the management center manages the driving state of a plurality of vehicles V and dispatches the vehicles V to designated places (destinations).

As shown in FIG. 1, the autonomous driving device 100 includes an ECU 20 for performing autonomous driving control. The ECU 20 is an electronic control unit having a Central Processing Unit [CPU], a Read Only Memory [ROM], a Random Access Memory [RAM], a Controller Area Network [CAN] communication circuit, and so on. The ECU 20 loads a program from the ROM into the RAM for causing the CPU to execute the program loaded in the RAM to implement various functions. The ECU 20 may be configured by a plurality of electronic control units. To the ECU 20, an external sensor 1, a Global Positioning System [GPS] receiver 2, an internal sensor 3, a map database 4, a door open/close sensor 5, a load sensor 6, a navigation system 7, an actuator 8, a Human Machine Interface [HMI] 9, and a communication unit 10 are connected.

The external sensor 1 is a detection apparatus that detects the surrounding situation of the vehicle V. The external sensor 1 includes at least one of a camera and a radar sensor. The camera is a capturing apparatus that captures the external situation of the vehicle V. The camera is provided on the interior side of the windshield of the vehicle V. The camera sends the captured information on the external situation of the vehicle V to the ECU 20. The camera may be a monocular camera or a stereo camera. The stereo camera includes two capturing units arranged so that the disparity between the right eye and the left eye can be reproduced. The information captured by the stereo camera also includes the depth direction information.

The radar sensor is a detection apparatus that detects obstacles around the vehicle V using radio waves (for example, millimeter waves) or light. The radar sensor includes, for example, a millimeter wave radar or a Light Detection and Ranging [LIDAR]. The radar sensor detects an obstacle by sending radio waves or light to the surroundings of the vehicle V and by receiving radio waves or light reflected by the obstacle. The radar sensor sends the detected obstacle information to the ECU 20. Obstacles include fixed obstacles such as guardrails and buildings as well as moving obstacles such as pedestrians, bicycles, and other vehicles.

The GPS receiver 2, mounted on the vehicle V, functions as a position measurement unit that measures the position of the vehicle V. The GPS receiver 2 receives signals from three or more GPS satellites to measure the position of the vehicle V (for example, latitude and longitude of the vehicle V). The GPS receiver 2 sends the measured position information on the vehicle V to the ECU 20.

The internal sensor 3 is a detection apparatus that detects the traveling state of the vehicle V. The internal sensor 3 includes at least one of a vehicle speed sensor, an acceleration sensor, and a yaw rate sensor. The vehicle speed sensor is a detection apparatus that detects the speed of the vehicle V. As the vehicle speed sensor, a wheel speed sensor is used. The wheel speed sensor is provided on the wheels of the vehicle V or on a component such as the drive shaft, which rotates in synchronization with the wheels, to detect the rotation speed of the wheels. The vehicle speed sensor sends the detected vehicle speed information to the ECU 20.

The acceleration sensor is a detection apparatus that detects the acceleration of the vehicle V. The acceleration sensor includes a longitudinal acceleration sensor that detects acceleration in the longitudinal direction of the vehicle V and a lateral acceleration sensor that detects acceleration in the lateral direction of the vehicle V. The acceleration sensor sends the acceleration information on the vehicle V to the ECU 20. The yaw rate sensor is a detection apparatus that detects the yaw rate (turning angle velocity) around the vertical axis at the center of gravity of the vehicle V. For example, a gyro sensor may be used as the yaw rate sensor. The yaw rate sensor sends the detected yaw rate information on the vehicle V to the ECU 20.

The map database 4 is a database that stores map information. The map database 4 is formed in a hard disk drive (HDD) mounted on the vehicle V. The map information includes the position information on roads, the information on road shapes, the position information on intersections and junctions, and speed limits of the roads. The information on a road shape includes the information on whether the road is a curved road or a straight road, the curvature of a curved road, the slope of a road surface (uphill, downhill), and so on. The map database 4 may be stored in a server that can communicate with the vehicle V.

The door open/close sensor 5 is a detection apparatus that detects the opening and closing of the door of the vehicle V. The door open/close sensor 5, installed around the door opening part of the vehicle body or on the doors of the vehicle V, detects the door open state and the door closed state. The door open/close sensor 5 outputs the detection result of the door open/closed state to the ECU 20.

The load sensor 6 detects the weight of the vehicle body of the vehicle V. For example, the load sensor 6, mounted around the suspension of the vehicle V, detects the weight of the vehicle body. The load sensor 6 outputs the weight detection result to the ECU 20.

The navigation system 7, mounted in the vehicle V, sets a target route along which the vehicle V will autonomously travel. The navigation system 7 calculates a target route from the position of the vehicle V to the destination, based on the preset destination, the position of the vehicle V measured by the GPS receiver 2, and the map information stored in the map database 4. The destination of autonomous driving control is set, for example, when the occupant of the vehicle V operates the input button (or touch panel) provided in the navigation system 7. In addition, the navigation system 7 wirelessly acquires a destination from the user of the vehicle V (a person who will use the vehicle V) or the management center and sets the acquired destination as the destination of autonomous driving control. That is, the navigation system 7 functions as a destination acceptance unit that accepts the setting of a destination. A target route is set by distinguishing the lanes of the road. The navigation system 7 can set a target route by a known method. The navigation system 7 notifies the driver about a target route by a display on the display device or a sound output from the speaker. The navigation system 7 outputs the information on the target route of the vehicle V to the ECU 20.

The actuator 8 is a device that performs the traveling control of the vehicle V. The actuator 8 includes at least a throttle actuator, a brake actuator, and a steering actuator. The throttle actuator controls the amount of air to be supplied to the engine (throttle angle) according to the control signal from the ECU 20 to control the driving force of the vehicle V. When the vehicle V is a hybrid vehicle, the amount of air to be supplied to the engine, as well as the control signal from the ECU 20 to the motor that works as the source of power, is received to control the driving force. When the vehicle V is an electric vehicle, the control signal from the ECU 20 to the motor, which works as the source of power, is received to control the driving force. The motor, which is used as the source of power in a hybrid vehicle or an electric vehicle, constitutes the actuator 8.

The brake actuator controls the brake system according to the control signal from the ECU 20 to control the braking force to be applied to the wheels of the vehicle V. As the brake system, a hydraulic brake system may be used. The steering actuator controls the driving of the assist motor, which is one component of the electric power steering system for controlling the steering torque, according to the control signal received from the ECU 20. By doing so, the steering actuator controls the steering torque of the vehicle V.

The HMI 9 is an interface for sending and receiving information between the driver and the autonomous driving device 100. The HMI 9 has a display for displaying image information to the driver, a speaker for outputting voices, input buttons or a touch panel for allowing the driver to perform input operations, and a voice input device. The HMI 9 sends the information, entered by the driver, to the ECU 20. The HMI 9 displays image information on the display device, and outputs voices via the speaker, according to the control signal from the ECU 20. The HMI 9 has a display device that displays image information, and a speaker that outputs voices, to the surroundings of the vehicle V.

The communication unit 10 has the function to communicate with the outside of the vehicle V. For example, the communication unit 10 can wirelessly communicate with the management center that manages the driving state of the vehicle V.

Next, the functional configuration of the ECU 20 will be described. The ECU 20 includes a vehicle position recognition unit 21, an external situation recognition unit 22, a traveling state recognition unit 23, a travel plan generation unit 24, an arrival determination unit 25, a getting in/out detection unit 26, a thing-left-behind detection unit 27, a notification unit 28, and a traveling control unit 29. Note that a part of the functions of the ECU 20 may be performed by a server capable of communicating with the vehicle V.

The vehicle position recognition unit 21 recognizes the position of the vehicle V on the map based on the position information received from the GPS receiver 2 and the map information stored in the map database 4. The vehicle position recognition unit 21 may use the position information on fixed obstacles, such as utility poles included in the map information stored in the map database 4, as well as the detection result detected by the external sensor 1, to recognize the position of the vehicle V on the map using an existing Simultaneous Localization and Mapping [SLAM] technology.

The external situation recognition unit 22 recognizes the external situation of the vehicle V based on the detection result of the external sensor 1. The external situation recognition unit 22 uses a known method to recognize the external situation of the vehicle V, including the position of an obstacle around the vehicle V, based on the image captured by the camera and/or the obstacle information detected by the radar sensor.

The traveling state recognition unit 23 recognizes the traveling state of the vehicle V, including the vehicle speed and direction of the vehicle V, based on the detection result of the internal sensor 3. More specifically, the traveling state recognition unit 23 recognizes the vehicle speed of the vehicle V based on the vehicle speed information received from the vehicle speed sensor. The traveling state recognition unit 23 recognizes the direction of the vehicle V based on the yaw rate information received from the yaw rate sensor.

The travel plan generation unit 24 generates a travel plan of the vehicle V based on the target route preset via the navigation system 7, the map information stored in the map database 4, the external situation of the vehicle V recognized by the external situation recognition unit 22, and the traveling state of the vehicle V recognized by the traveling state recognition unit 23. This travel plan is a travel plan from the current position of the vehicle V until the vehicle arrives at the preset destination.

A travel plan includes control target values of the vehicle V each of which corresponds to a position of the vehicle V on the target route. A position on the target route refers to a position on the target route on the map in the extending direction. A position on the target route means a set longitudinal position that is set at a predetermined interval (for example, 1 m) in the extending direction of the target route. A control target value refers to a value used in the travel plan as a control target of the vehicle V. The control target value is set in association with each set longitudinal position on the target route. The travel plan generation unit 24 generates a travel plan by setting the set longitudinal positions on the target route at a predetermined interval and, at the same time, by setting the control target values (for example, target lateral position and the target vehicle speed) for each set longitudinal position. The set longitudinal position and the target lateral position may be combined and set as one set of position coordinates. The set longitudinal position and the target lateral position mean the longitudinal position information and the lateral position information that are set as a target in the travel plan.

The arrival determination unit 25 determines whether the vehicle V has arrived at the destination. The destination in this case is the destination that is set in the navigation system 7. More specifically, the arrival determination unit 25 determines whether the vehicle V has arrived at the destination based on the position of the vehicle V on the map recognized by the vehicle position recognition unit 21. The arrival determination unit 25 may determine that the vehicle V has arrived at the destination when the vehicle V remains stationary at the destination continuously for a predetermined arrival determination time or longer after the vehicle V arrives at the destination. In other words, the arrival determination unit 25 does not determine that the vehicle V has arrived at the destination when the vehicle V simply passes the destination.

The getting in/out detection unit 26 detects whether an occupant gets in or out of the vehicle V. More specifically, when the detection result of the door open/close sensor 5 changes from the closed state to the open state with an occupant not in the vehicle V, the getting in/out detection unit 26 determines that the occupant has gotten in the vehicle V. Similarly, when the detection result of the door open/close sensor 5 changes from the closed state to the open state with an occupant in the vehicle V, the getting in/out detection unit 26 determines that the occupant has gotten out of the vehicle V.

The thing-left-behind detection unit 27 compares the state of the vehicle V before an occupant gets in the vehicle and the state of the vehicle V after the occupant gets out of the vehicle to detect whether there is a thing left behind in the vehicle V. More specifically, the thing-left-behind detection unit 27 detects whether there is a thing left behind based on the weight detected by the load sensor 6. For example, the thing-left-behind detection unit 27 compares the weight of the vehicle body detected by the load sensor 6 before an occupant gets in the vehicle and the weight of the vehicle body detected by the load sensor 6 after the occupant gets out of the vehicle. If the weight of the vehicle body after the occupant gets out of the vehicle is heavier than the weight of the vehicle body before the occupant gets in the vehicle, the thing-left-behind detection unit 27 detects that there is a thing left behind in the vehicle V. If the weight of the vehicle body before an occupant gets in the vehicle is equal to the weight of the vehicle body after the occupant gets out of the vehicle, the thing-left-behind detection unit 27 detects that there is not a thing left behind in the vehicle V.

The notification unit 28 sends a notification to the outside of the vehicle V according to whether the occupant has gotten in/out of the vehicle. More specifically, the notification unit 28 sends a notification if it is not detected by the getting in/out detection unit 26 that the occupant has gotten in/out of the vehicle within a predetermined getting-in/out determination time after the arrival determination unit 25 determines that vehicle has arrived at the destination. That is, the notification unit 28 sends a notification to indicate that the occupant has not gotten out of the vehicle if it is not detected that the occupant has gotten out of the vehicle within the getting-in/out determination time after it is determined that the vehicle has arrived at the destination with the occupant in the vehicle V. Similarly, the notification unit 28 sends a notification to indicate that the occupant has not gotten in the vehicle if it is not detected that the occupant has gotten in the vehicle within the getting-in/out determination time after it is determined that the vehicle has arrived at the destination with no occupant in the vehicle V.

In addition, the notification unit 28 sends a notification to the outside of the vehicle V to indicate that there is a thing left behind if the getting in/out detection unit 26 detects that the occupant has gotten out of the vehicle and if the thing-left-behind detection unit 27 detects that there is a thing left behind, after the vehicle V has arrived at the destination with the occupant in the vehicle V.

The notification unit 28 sends the notification described above to the management center, which manages the driving state of the vehicle V, through the communication unit 10. In addition to the management center, the notification unit 28 may send the notification to the customer center, installed in the manufacturer of the vehicle V, or to a public emergency report center (for example, the police station, the fire station, etc.). The notification unit 28 may also send the notification described above to the surroundings of the vehicle V using the devices provided in the HMI 9 such as the display, which displays image information, and the speaker which outputs sound. For example, if it is detected that there is a thing left behind, the notification unit 28 may send the notification to the mobile terminal of the occupant who has gotten out of the vehicle V.

If the autonomous driving device 100 is capable of detecting the state in the vehicle V, the notification unit 28 may send a notification according to the state in the vehicle V. For example, the autonomous driving device 100 has a sensor that detects the temperature in the vehicle V. If an abnormality, such as an abnormal temperature in the vehicle V, is detected by this sensor, the notification unit 28 may send a notification to an emergency report center and may send a sound notification and a light notification to the surroundings of the vehicle V. In addition, the autonomous driving device 100 has an occupant state detection unit that detects whether the state of the occupant in the vehicle V is abnormal. For example, the state of the occupant of the vehicle V may be a health condition. The occupant state detection unit may use a known image processing technique to detect whether the state of the occupant is good or bad, based on the captured camera image of the occupant. For example, the occupant state detection unit may recognize the occupant's posture from the camera image and, if the occupant gets sick and falls in the vehicle V, detect that the state of the occupant is abnormal. Note that the occupant state detection unit does not necessarily need to use a camera image but may be configured in various ways. If the occupant state detection unit detects that the state of the occupant is abnormal, the notification unit 28 may send a notification to an emergency report center and may send a sound notification and a light notification to the surroundings of the vehicle V.

A notification indicating the state in the vehicle V, which is sent by the notification unit 28, may be sent in addition to, or in place of, a notification that is sent upon arrival at the destination based on the detection result of the getting in/out detection unit 26, or may be sent immediately when an abnormality is detected.

The traveling control unit 29 causes the vehicle V to autonomously travel (manned or unmanned) to the destination along the route. When an occupant is in the vehicle V, the traveling control unit 29 causes the vehicle V to autonomously travel to the destination based on an instruction entered by the occupant to start autonomous driving control. In this case, the traveling control unit 29 may perform autonomous driving control when a predetermined condition is satisfied. On the other hand, when an occupant is not in the vehicle V, the traveling control unit 29 causes the vehicle V to autonomously travel to the destination based on an instruction to start autonomous driving control that is either entered by the user of the vehicle V (a person who will use the vehicle V) or sent from the management center.

More specifically, the traveling control unit 29 performs autonomous driving control, including the speed control and steering control of the vehicle V, based on the position of the vehicle V on the map recognized by the vehicle position recognition unit 21 and on the travel plan generated by the travel plan generation unit 24. The traveling control unit 29 performs autonomous driving control by sending the control signal to the actuator 8. The traveling control unit 29 performs autonomous driving control to place the vehicle V in the autonomous driving state.

Next, the flow of the processing (notification method), such as the notification processing, executed by the autonomous driving device 100 when an occupant gets in and out of the vehicle will be described. Two flows are described below: one is the flow executed when the autonomous driving device 100 causes the vehicle V to travel in manned mode and the other is the flow executed when the autonomous driving device 100 causes the vehicle V to travel in unmanned mode.

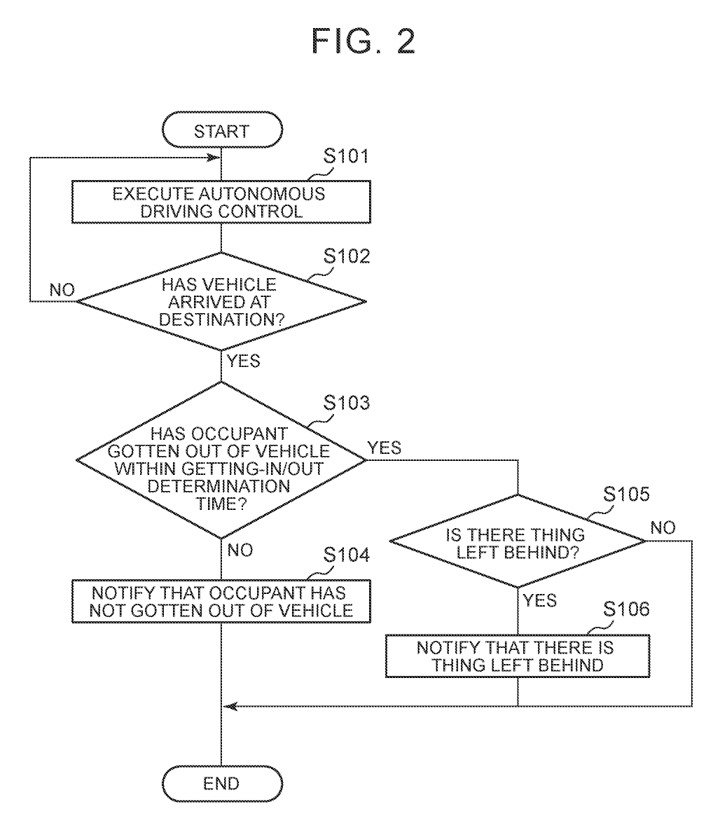

First, the flow of the notification processing executed when the autonomous driving device 100 causes the vehicle V to travel in manned mode will be described with reference to FIG. 2. This flow corresponds, for example, to the case in which an occupant is transported to the destination under autonomous driving control. The processing shown in FIG. 2 is started when an instruction to start autonomous driving control is entered by the occupant who gets in the vehicle V. It is assumed that, before starting the execution of autonomous driving control, the destination is set in advance by the occupant and the travel plan is generated by the travel plan generation unit 24.

As shown in FIG. 2, when an instruction to start the execution of autonomous driving control is given, the traveling control unit 29 executes autonomous driving control, based on the travel plan generated by the travel plan generation unit 24, to cause the vehicle V to travel autonomously to the destination (S101). Next, the arrival determination unit 25 determines whether the vehicle V has arrived at the destination (S102: arrival determination step). If the vehicle V has not arrived at the destination (S102: NO), the traveling control unit 29 continues the execution of autonomous driving control (S101). That is, the processing in S101 is continuously executed until the vehicle V arrives at the destination.

If the vehicle V has arrived at the destination (S102: YES), the notification unit 28 determines whether the getting in/out detection unit 26 detects that the occupant has gotten out of the vehicle within the getting-in/out determination time (S103). If it is not detected that the occupant has gotten out of the vehicle within the getting-in/out determination time (S103: NO), the notification unit 28 sends a notification to the management center to indicate that the occupant has not gotten out of the vehicle (S104: notification step). After sending the notification to the management center, the autonomous driving device 100 terminates the current processing. This sequence of steps allows the administrator of the management center to know that the occupant has not gotten out of the vehicle, enabling the administrator to take various actions, for example, an action to send a person to the destination to confirm the state.

On the other hand, if it is detected that the occupant has gotten out of the vehicle within the getting-in/out determination time (S103: YES), the thing-left-behind detection unit 27 detects whether there is a thing left behind in the vehicle V (S105). If there is a thing left behind (S105: YES), the notification unit 28 sends a notification to the management center to indicate that there is a thing left behind (S106). After sending the notification to the management center, the autonomous driving device 100 terminates the current processing. If there is not a thing left behind after the occupant has gotten out of the vehicle (S105: NO), the autonomous driving device 100 terminates the current processing.

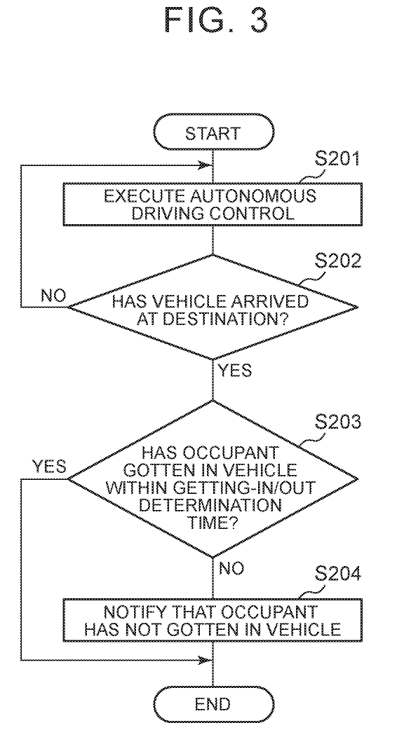

Next, the flow of the notification processing executed when the autonomous driving device 100 causes the vehicle V to travel in unmanned mode will be described with reference to FIG. 3. This flow corresponds, for example, to the case in which the vehicle V picks up a user waiting at a predetermined place. The processing shown in FIG. 3 is started when an instruction to start autonomous driving control is entered by the user of the vehicle V (a person who will use the vehicle V) or the management center. It is assumed that, before starting the execution of autonomous driving control, the destination is set in advance by the user of the vehicle V (a person who will use the vehicle V) or by the management center via wireless communication and the travel plan is generated by the travel plan generation unit 24.

As shown in FIG. 3, when an instruction to start the execution of autonomous driving control is given, the traveling control unit 29 executes autonomous driving control, based on the travel plan generated by the travel plan generation unit 24, to cause the vehicle V to travel autonomously to the destination (where the user is waiting) (S201). Next, the arrival determination unit 25 determines whether the vehicle V has arrived at the destination (S202: arrival determination step). If the vehicle V has not arrived at the destination (S202: NO), the traveling control unit 29 continues the execution of autonomous driving control (S201). That is, the processing in S201 is continuously executed until the vehicle V arrives at the destination.

If the vehicle V has arrived at the destination (S202: YES), the notification unit 28 determines whether the getting in/out detection unit 26 detects that the occupant (user) has gotten in the vehicle within the getting-in/out determination time (S203). If it is not detected that the occupant has gotten in the vehicle within the getting-in/out determination time (S203: NO), the notification unit 28 sends a notification to the management center to indicate that the occupant has not gotten in the vehicle (S204: notification step). After sending the notification to the management center, the autonomous driving device 100 terminates the current processing. This sequence of steps allows the administrator of the management center to know that the occupant has not gotten in the vehicle, enabling the administrator to take various actions, for example, an action to cause the vehicle V to move to another place. If it is detected that the occupant has gotten in the vehicle within the getting-in/out determination time (S203: YES), the autonomous driving device 100 terminates the current processing.

This embodiment is configured as described above. That is, if it is not detected that the occupant has gotten in or out of the vehicle within the getting-in/out determination time after it is determined that the vehicle has arrived at the destination, the autonomous driving device 100 sends a notification to the management center external to the vehicle V. In this configuration, the autonomous driving device 100 sends a notification as follows. For example, if the occupant cannot get out of the vehicle due to an abnormality in the occupant's state after the vehicle V has travelled to the preset destination with the occupant in the vehicle, the autonomous driving device 100 can send a notification to the management center to notify about the condition. In addition, if a user is not present at the destination and, therefore, does not get in the vehicle V after the vehicle V has travelled to the preset destination with no occupant in the vehicle to pick up the user, the autonomous driving device 100 can send a notification to the management center to notify about the condition. Based on these notifications, the notified manager can know that an abnormality has occurred in the vehicle V or in the occupant's state. In this way, after the vehicle V capable of autonomous driving arrives at the preset destination, the autonomous driving device 100 can send a notification according to whether the occupant has gotten in/out of the vehicle. In this way, the autonomous driving device 100 enables the notified administrator to take various actions according to the notification.

In addition, if the vehicle V used for the vehicle dispatch service has arrived at a destination preset for picking up a user but if the user does not get in the vehicle V, there is a possibility of an abuse of the service. An example of abuse in this case is that a request for dispatching the vehicle V is made although there is no intention of getting in the vehicle. Even when such an abuse is made, the autonomous driving device 100 sends a notification to allow the notified manager, who has received the notification, to confirm the abuse at an early stage. This prevents the usage efficiency of the vehicle V in the vehicle dispatch service from being lowered.

The autonomous driving device 100 sends a notification also if there is a thing left behind in the vehicle V when an occupant gets out of the vehicle. This allows the administrator, who has received the notification, or the occupant, who has gotten out of the vehicle V, to know that there is a thing left behind in the vehicle V, thus preventing the occupant from losing belongings.

The arrival determination unit 25 determines that the vehicle V has arrived at the destination when the vehicle V arrives at the destination and, after that, remains stationary at the destination continuously for the predetermined arrival determination time or longer. This means that the autonomous driving device 100 can detect that the vehicle V has arrived at the destination, not when the vehicle V simply passes the destination, but when the vehicle V arrives at the destination and remains stationary there in the state in which the occupant can get in or out of the vehicle.

Although the embodiment of the present disclosure has been described above, the present disclosure is not limited to the above embodiment. For example, the getting in/out detection unit 26 may detect whether an occupant has gotten in/out of the vehicle based on a detection result other than that of the door open/close sensor 5. The getting in/out detection unit 26 may detect whether an occupant has gotten in/out of the vehicle, for example, based on the detection result of the load sensor 6. In this case, the getting in/out detection unit 26 may detect that the occupant has gotten in the vehicle when the load sensor 6 detects that the vehicle body becomes heavier. Conversely, the getting in/out detection unit 26 may detect that the occupant has gotten out of the vehicle when the load sensor 6 detects that the vehicle body becomes lighter.

The getting in/out detection unit 26 may detect whether an occupant is in the vehicle based on the detection result of the seating sensor (pressure sensor) attached to the seat on which the occupant sits. The getting in/out detection unit 26 may detect whether an occupant is in the vehicle based on a camera image generated by capturing the interior of the vehicle V. Detection of whether an occupant is in the vehicle based on a camera image can be made using a known image processing technology. The getting in/out detection unit 26 may detect a moving object in the vehicle V, that is, an occupant, using an infrared ray sensor mounted in the vehicle V.

The thing-left-behind detection unit 27 may detect whether there is a thing left behind based on the detection result other than that of the load sensor 6. For example, the thing-left-behind detection unit 27 may detect whether there is a thing left behind based on a camera image generated by capturing the interior the vehicle V. In this case, the thing-left-behind detection unit 27 detects that there is a thing left behind when an object that was not found before an occupant gets in the vehicle V is found after the occupant gets out of the vehicle. Detection of an object based on a camera image can be made using a known image processing technology. The thing-left-behind detection unit 27 may also detect whether there is a thing left behind based on the detection result of the seating sensor (pressure sensor) attached to the seat on which the occupant sits. For example, if an object is detected on the seat by the seating sensor after the occupant gets out of the vehicle, the thing-left-behind detection unit 27 detects that there is a thing left behind.

Note that the autonomous driving device 100 need not necessarily have the thing-left-behind detection unit 27 for detecting a thing left behind. The navigation system 7 is not a system that functions only as a destination acceptance unit for accepting the setting of a destination. In addition to the navigation system 7, the autonomous driving device 100 may have a destination acceptance unit for accepting the setting of a destination. The configuration for causing the vehicle V to autonomously travel is not limited to the configuration described in the embodiment, but various configurations may be used.

What is claimed is:

1. An autonomous driving device comprising:
a traveling control unit configured to cause a vehicle to autonomously travel to a destination;
an arrival determination unit configured to determine whether the vehicle has arrived at the destination;
a getting in-out detection unit configured to detect whether an occupant has gotten in or gotten out of the vehicle; and
a notification unit configured to send a notification to an outside of the vehicle when the getting in-out detection unit does not detect that the occupant has gotten in or gotten out of the vehicle within a predetermined getting in-out determination time after the arrival determination unit determines that the vehicle has arrived at the destination.

2. The autonomous driving device according to claim 1, wherein
the traveling control unit is configured to cause the vehicle to travel in unmanned mode and
the notification unit is configured to send the notification to the outside to indicate that the occupant has not gotten in the vehicle when the getting in-out detection unit does not detect that the occupant has gotten in the vehicle within the predetermined getting in-out determination time after the vehicle has arrived at the destination.

3. The autonomous driving device according to claim 1, wherein
the traveling control unit is configured to cause the vehicle to travel in manned mode and
the notification unit is configured to send the notification to the outside to indicate that the occupant has not gotten out of the vehicle when the getting in-out detection unit does not detect that the occupant has gotten out of the vehicle within the predetermined getting in-out determination time after the vehicle has arrived at the destination.

4. The autonomous driving device according to claim 1, wherein
the notification is sent to a reception device external to the vehicle.

5. The autonomous driving device according claim 1, wherein
the notification is output using a sound, a light, or a display.

6. The autonomous driving device according to claim 1, further comprising
a travel plan generation unit configured to determine a route to the destination wherein
the traveling control unit is configured to cause the vehicle to autonomously travel along the route.

7. The autonomous driving device according to claim 1, further comprising
a destination acceptance unit configured to accept a setting of the destination.

8. The autonomous driving device according to claim 1, wherein
the getting in-out detection unit is configured to detect whether the occupant has gotten in or gotten out of the vehicle based on a detection result of a sensor or an image of an interior of the vehicle captured by a camera.

9. The autonomous driving device according to claim 8, wherein
the sensor includes at least one of a door open-close sensor, a load sensor, a seating sensor, or an infrared ray sensor,
the door open-close sensor is configured to detect whether a door is open or closed,
the load sensor is configured to detect a weight of the vehicle,
the seating sensor is configured to detect a pressure applied to a seat.

10. The autonomous driving device according to claim 1, wherein
the arrival determination unit is configured to determine whether the vehicle has arrived at the destination based on vehicle position information including a position of the vehicle on a map at a time when the arrival determination unit determines whether the vehicle has arrived at the destination.

11. The autonomous driving device according to claim 10, wherein
the position of the vehicle on the map is recognized based on map information stored in a map database and Global Positioning System information entered externally.

12. The autonomous driving device according to claim 10, wherein
the position of the vehicle on the map is recognized based on map information stored in a map database and a detection result of an external sensor mounted on the vehicle, the external sensor being configured to detect a surrounding situation of the vehicle

13. The autonomous driving device according to claim 1, wherein
the arrival determination unit is configured to determine that the vehicle has arrived at the destination when the vehicle remains stationary at the destination continuously for a predetermined arrival determination time or longer after the vehicle arrives at the destination.

14. The autonomous driving device according to claim 1, further comprising
a thing-left-behind detection unit configured to detect whether there is a thing left behind in the vehicle by comparing a state of the vehicle before the occupant gets in the vehicle and a state of the vehicle after the occupant gets out of the vehicle,
wherein
the notification unit is configured to send a notification to the outside of the vehicle when the getting in-out detection unit detects that the occupant has gotten out of the vehicle and when the thing-left-behind detection unit detects that there is a thing left behind.

15. The autonomous driving device according to claim 14, wherein
the notification is sent to a reception device external to the vehicle.

16. The autonomous driving device according to claim 15, wherein
the reception device is a mobile terminal of the occupant.

17. A notification method which is performed in an autonomous driving device causing a vehicle to autonomously travel along a route to a destination in manned mode or unmanned mode comprising:
determining whether the vehicle has arrived at the destination; and
sending, after determining that the vehicle has arrived at the destination in the determining whether the vehicle has arrived at the destination, a notification to an outside of the vehicle when getting in or getting out of the vehicle of an occupant is not detected within a predetermined getting in-out determination time.

18. A autonomous driving device comprising
an Electronic Control Unit configured to:
cause a vehicle to autonomously travel to a destination;
determine whether the vehicle has arrived at the destination;
detect whether an occupant has gotten in or gotten out of the vehicle; and
send a notification to an outside of the vehicle when getting in or getting out of the vehicle of the occupant is not detected within a predetermined getting in-out determination time after arrival of the vehicle at the destination is determined.
